(19) United States
(12) Patent Application Publication
(10) Pub. No.: US 2008/0179485 A1
(43) Pub. Date: Jul. 31, 2008

(54) Vehicular side mirror

(76) Inventor: Kun-Shan Yang, Yong Kang city (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/699,566

(22) Filed: Jan. 30, 2007

(51) Int. Cl. B60R 1/06

(52) U.S. Cl. 248/475.1

(57) ABSTRACT

A vehicular side mirror includes a base, supports and a mirror holder. The bas has pivoting portions and locating portions. A locking rod is provided on the locking portions and urged by an elastic element. One end of each support is disposed with a pivoting block pivoted to the pivoting portion of the base. The other end of each support is disposed with a locking block. Locking recesses are disposed on the perimeter of the pivoting block and secured in position by the locking rod of the base. The mirror holder is inserted onto the supports and comprises sliding channels. Both ends of each sliding channel are respectively disposed with a first limit block and a second limit block to restrict sliding movement of the locking block of the support to allow the mirror holder be firmly secured in place when extended or retracted.

### BACKGROUND OF THE INVENTION

(a) Field of the Invention

The present invention relates to a vehicular side mirror, and more particularly, to one that is capable of securing a mirror holder in position when it is retracted or extended by means of locking recesses provided on a pivoting block of a support to be secured in position by a locking rod and a locking block of the support being restricted from sliding by a first limit block and a second limit block respectively provided in a sliding channel of the mirror holder.

(b) Description of the Prior Art

Whereas a heavy-duty automobile, particularly a truck tractor coupled with a semi-trailer or a flatted trailer on the road is built larger, wider, and longer, it is exposed to more dead angles in its rear view. Therefore, the truck tractor relies much upon side mirrors to watch at any time for the pedestrians and cars following behind it. Accordingly, the side mirror adapted to the truck tractor is larger and must be collapsible since it is necessary for the side mirror to be folded in so as to prevent obstructing the traffic when the truck tractor parks on roadside. Outsider mirrors generally available in the market is each essentially comprised of a mirror, an adjustment base, an externally curved arm, a base, and a casing. The greater number of the members involved makes the manufacturing or assembly very complicated. The extension or folding of the side mirror is secured in position only means of a coil which is vulnerable to fall out of place since the stress sustainable by the coil is very limited. Furthermore, the folding is insecure since it is merely achieved by placement as limited by the angle of a gap provided on the casing without any locking means to present safety concerns and inconvenient operation in use.

### SUMMARY OF THE INVENTION

The primary purpose of the present invention is to provide a vehicular side mirror to correct the flaws found with the prior art. According to one aspect of the present invention, there is provided a vehicular side mirror comprising supports and a mirror holder, each said support being sleeved with a casing tube, one end of each said support being provided with a locking block; fixing tubes extending from said mirror holder to insert onto the casing tube of each said support, the mirror holder having sliding channels for the locking block of each said support to slide therein, two ends of each said sliding channel being respectively disposed with a first limit block and a second limit block to restrict sliding movement by the locking block of each said support. Said mirror holder further comprises retaining blocks corresponding in position to said sliding channels, each said retaining block having a retaining channel, said sliding channel and said retaining channel packing against said support.

According to another aspect of the present invention, there is provided a vehicular side mirror comprising a base having pivoting portions and locating portions corresponding in position to said pivoting portions, a locking rod being provided on said locating portions, said locking rod being urged by an elastic member; supports pivotally connected to said base, each said support having one end disposed with a pivoting block and an opposite end disposed with a locking block, said pivoting block being pivotally connected to said pivoting portion of said base, locking recesses being disposed on the perimeter of said pivoting block, each said support further comprising a casing tube extending from an outer side of said pivoting block; and a mirror holder inserted onto said supports, said mirror holder having sliding channels therein and fixing tubes extending from one side of said mirror holder, two ends of each said sliding channel being respectively disposed with a first limit block and a second limit block to restrict sliding movement of said locking block of each said support. Said mirror holder further comprises retaining blocks corresponding in position to said sliding channels, each said retaining block having a retaining channel, said sliding channel and said retaining channel packing against said support.

The preset invention provides the following advantages:

1. Simplified members to allow easy and faster assembly.

2. The mirror holder once folded in is firmly secured in position since the pivoting block of the support is locked in position by the locking rod in the base.

3. A sliding channel disposed in the mirror hold has its both ends respectively provided with the first and the second limit blocks to restrict sliding therein of the locking of the support without falling out of place.

4. The support stays in place without engaging any wild sliding once the mirror holder is extended or retracted since the both of the sliding channel and the retaining channel of the mirror holder properly pack the support.

### BRIEF DESCRIPTION OF THE DRAWINGS

FIG. 1 is a schematic view showing an appearance of the present invention.

FIG. 2 is a schematic view showing an internal combination of the present invention.

FIG. 3 is a schematic view showing a mirror holder in the present invention is retracted.

FIG. 4 is a schematic view showing the mirror holder in the present invention is extend.

FIG. 5 is a schematic view showing a status of the mirror holder in the present invention before being folded in.

FIG. 6 is a schematic view showing an operating status of folding in the mirror holder in the present invention.

FIG. 7 is a schematic view showing that a support is packed by a sliding channel and a retaining channel in the present invention.

### DETAILED DESCRIPTION OF THE PREFERRED EMBODIMENTS

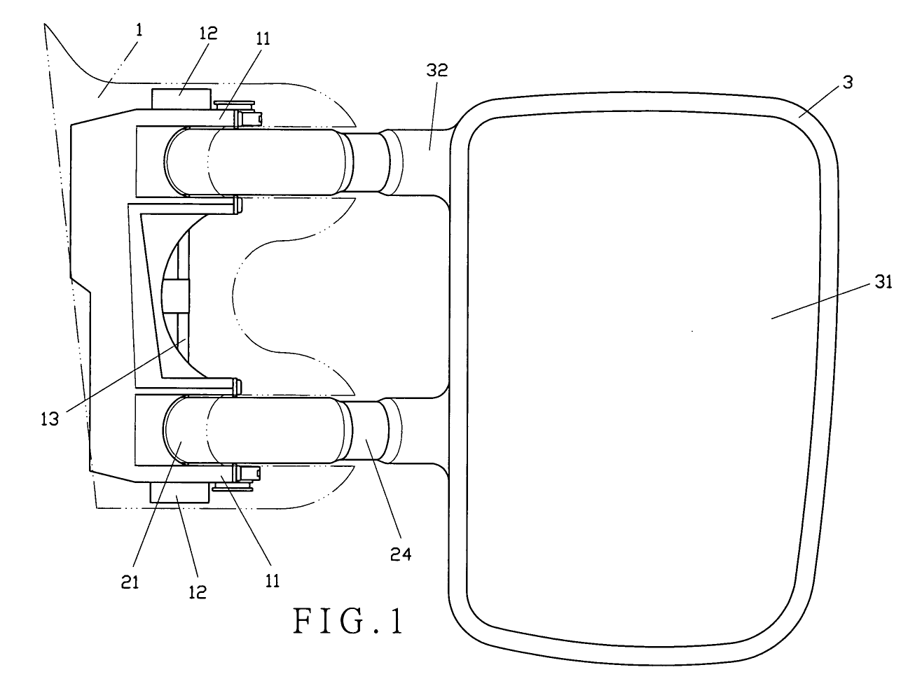

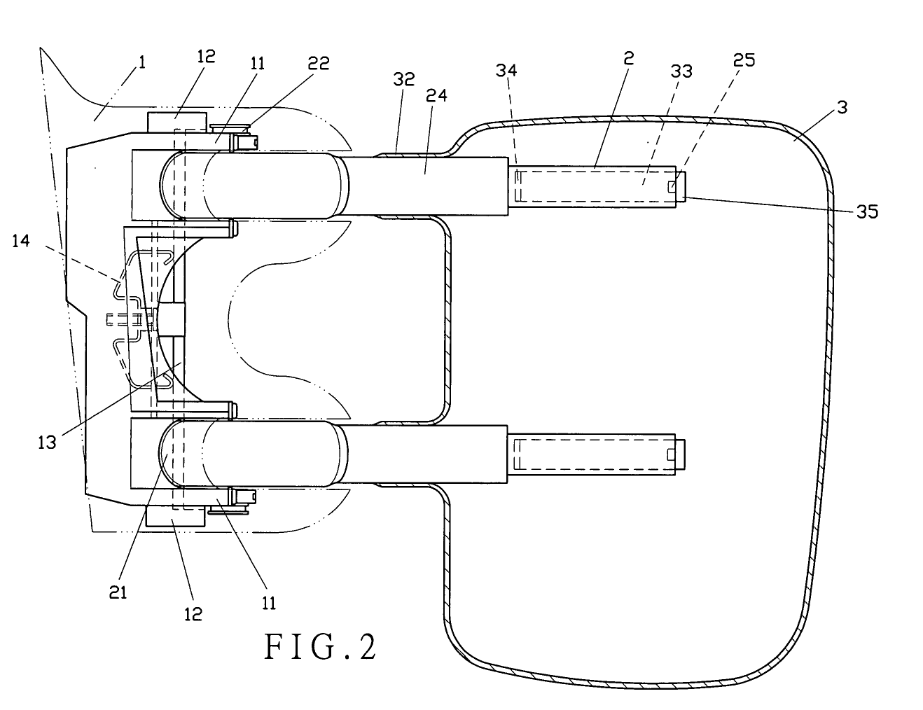

Referring to FIGS. 1, 2 and 3, a preferred embodiment of the present invention comprises a base (1), two supports (2), and a mirror holder (3).

The base (1) comprises two pivoting portions (11) and two locating portions (12) corresponding in position to the pivoting portions (11). A locking rod (13) is provided on the locating portions (12). The locking rod (13) is urged by an elastic member (14) to execute displacement of extension or retraction.

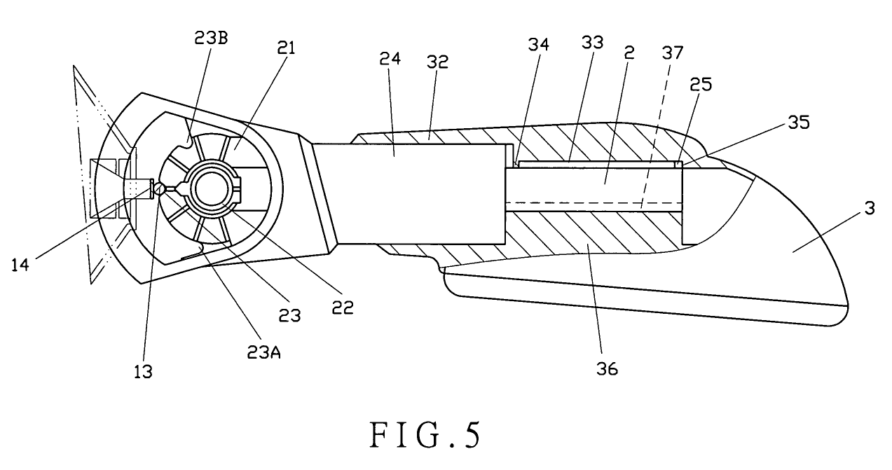

The supports (2) are pivotally connected to the base (1). A pivoting block (21) is provided at one end of each support (2), and a locking block (25) is provided at the other end of each support (2). A pivoting member (22) inserting through the pivoting block (21) is pivotally connected to the pivoting portion (11) of the base (1). The pivoting block (21) is formed with locking recesses (23), (23A), and 23(B), as illustrated in FIG. 5, with each to be locked in position by the locking rod (13) of the base (1). Each support (2) is provided with a casing tube (24) extending from the outer end of the pivoting block (21).

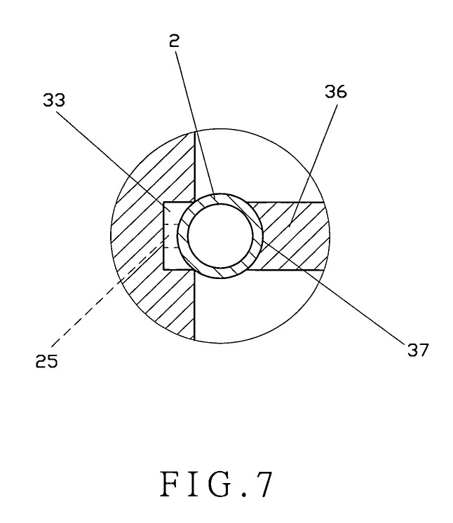

The mirror holder (3) is inserted onto the supports (2). A reflector (31) is provided on the mirror holder (3). Two fixing tubes (32) extend from one side of the mirror holder (3) to insert onto the outer side of each casing tube (24). The inner wall of the mirror holder (3) is provided with two sliding channels (33) corresponding in position to the fixing tubes (32). Each sliding channel (33) compromises the camber of the outer edge of the support (2) for the support (2) to slide in the sliding channel (33). Both ends of each sliding channel (33) are respectively provided with a first limit block (34) and a second limit block (35) thus to restrict the locking block (25) of the support (2) to move therein without falling out of place. The mirror holder (3) further comprises a retaining block (36) corresponding in position to the sliding channel (33), as illustrated in FIG. 7. A retaining channel (37) is disposed in the retaining block (36) for both the sliding channel (33) and the retaining channel (37) to properly pack against the support (2) upon completing the sliding movement.

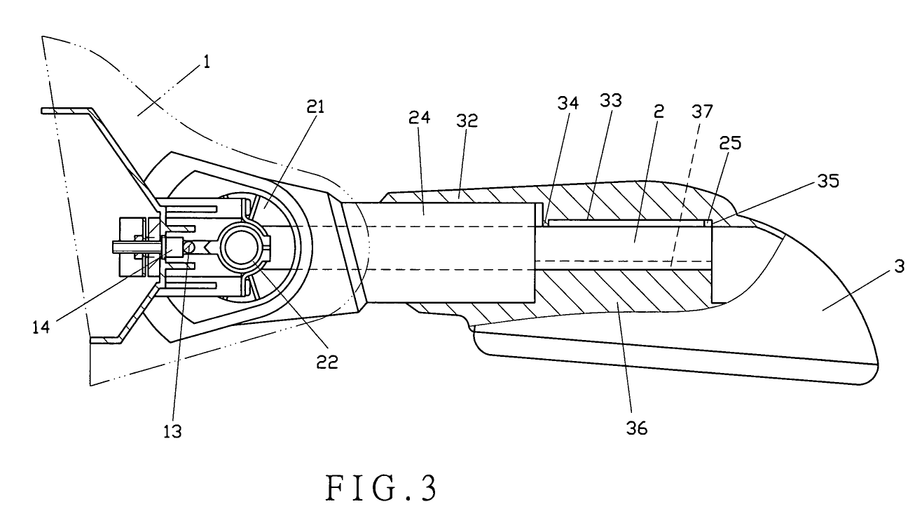

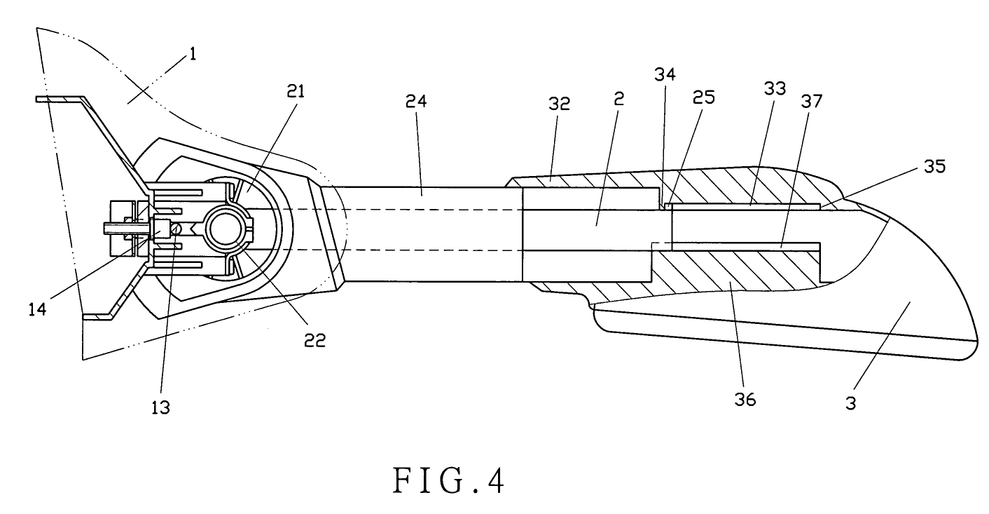

In operation as illustrated in FIG. 4, to extend the mirror holder (3) on the base (1), the mirror holder (3) is pulled outwardly for each fixing tube (32) of the mirror holder (3) to move on the outer side of the casing tube (24) of the support (2). The locking block (25) disposed on one end of the support (2) slides in the sliding channel (33) of the mirror holder (3) and locked by the first limit block (34) to prevent the mirror holder (3) and the support (2) from disengaging each other, and both the sliding channel (33) and the retaining channel (47) of the mirror holder (3) properly pack against the support (2) to hold it in position. To retract the mirror holder (3) as illustrated in FIG. 3, the mirror holder (3) is pushed in for each fixing tube (32) of the mirror holder (3) to move inwardly on the outer side of the casing tube (24) of the support (2). The locking block (25) disposed at one end of the support (2) slides in the sliding channel (33) of the mirror holder (3) to be locked by the second limit block (34) to prevent the mirror holder (3) from hitting its inner wall. Both the sliding channel (33) and the retaining channel (37) of the mirror holder (3) properly pack against the support (2) in position upon completing the sliding movement.

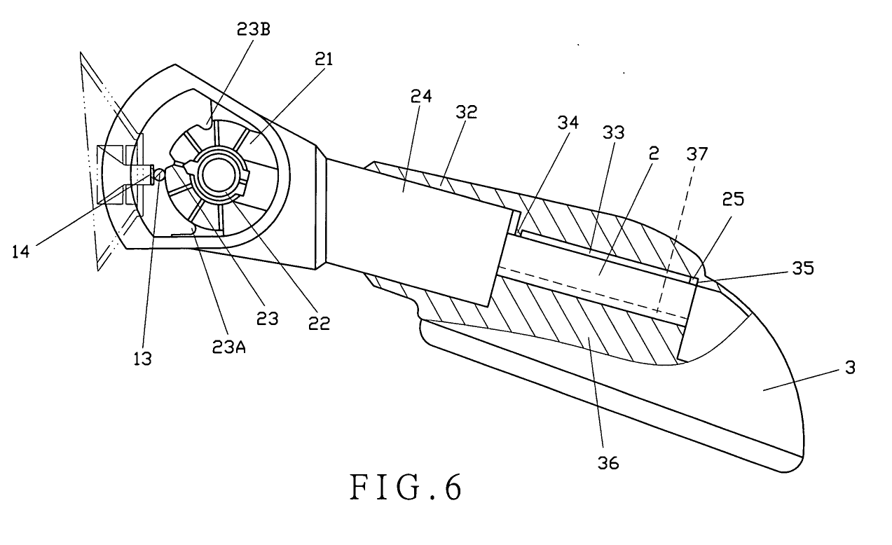

To fold in the mirror holder (3) as illustrated in FIGS. 5 and 6, the mirror holder (3) is folded in clockwise (or counterclockwise) in relation to the base (1). Each casing tube (24) of the support (2) folds in as driven by the fixing tube (32). In turn the pivoting block (21) of the support (2) rotates in relation to the pivoting portion (11) of the base (1). When the pivoting block (21) is rotated, the locking recess (23) provided on the pivoting block (21) drives the locking rod (13) of the base (1) for the locking rod (13) to press against the elastic member (14) thus to disengage the locking rod (13) from the locking recess (23) to facilitate the mirror holder (3) to turn around clockwise (or counterclockwise). Once the locking block (21) is rotated to where another locking recess (23A) or (23B) is aligned at the locking rod (13), the locking rod (13) for being subject to the elastic force from the elastic member (14) is locked into the locking recess (23A) or (23B) of the pivoting block (21) thus to secure the mirror holder (3) in the base (1).

What is claimed is:

1. A vehicular side mirror, comprising:
supports, each said support being sleeved with a casing tube, one end of each said support being provided with a locking block; and
a mirror holder, fixing tubes extending from said mirror holder to insert onto said casing tube of each said support, said mirror holder having sliding channels for said locking block of each said support to slide therein, two ends of each said sliding channel being respectively disposed with a first limit block and a second limit block to restrict sliding movement of the locking block of each said support.

2. The vehicular side mirror as claimed in claim 1, wherein said mirror holder further comprises retaining blocks corresponding in position to said sliding channels, each said retaining block having a retaining channel, said sliding channel and said retaining channel packing against said support.

3. A vehicular side mirror, comprising:
a base having pivoting portions and locating portions corresponding in position to said pivoting portions, a locking rod being provided on said locating portions, said locking rod being urged by an elastic member;
supports pivotally connected to said base, each said support having one end disposed with a pivoting block and an opposite end disposed with a locking block, said pivoting block being pivotally connected to said pivoting portion of said base, locking recesses being disposed on the perimeter of said pivoting block, each said support further comprising a casing tube extending from an outer side of said pivoting block; and
a mirror holder inserted onto said supports, said mirror holder having sliding channels therein and fixing tubes extending from one side of said mirror holder, two ends of each said sliding channel being respectively disposed with a first limit block and a second limit block to restrict sliding movement of said locking block of each said support.

4. The vehicular side mirror as claimed in claim 3, wherein said mirror holder further comprises retaining blocks corresponding in position to said sliding channels, each said retaining block having a retaining channel, said sliding channel and said retaining channel packing against said support.
